(19) United States
(12) Patent Application Publication
(10) Pub. No.: US 2025/0363961 A1
(43) Pub. Date: Nov. 27, 2025

(54) DISPLAY DEVICE AND DISPLAY METHOD

(71) Applicant: SHARP KABUSHIKI KAISHA, Sakai City (JP)

(72) Inventors: Takashi KANDA, Sakai City (JP); Yuichi MARUHASHI, Sakai City (JP)

(21) Appl. No.: 19/207,627

(22) Filed: May 14, 2025

(30) Foreign Application Priority Data
May 22, 2024 (JP) 2024-083556
Feb. 27, 2025 (JP) 2025-030592

(51) Int. Cl. G09G 3/34

(52) U.S. Cl. CPC G09G 3/3426; G09G 2320/0238; G09G 2320/0247; G09G 2320/0261; G09G 2320/0686; G09G 2320/106; G09G 2360/145

(57) ABSTRACT

A display device according to an embodiment is provided with a display panel, a backlight, and a backlight controller which divides the backlight into a plurality of areas, and controls a light-emission luminance of the backlight for each of the plurality of areas on the basis of an image signal. The backlight controller causes the light-emission luminance of the backlight in a first adjacent illumination area which is adjacent, in a direction in which an image included in the image signal moves, to the image to be changed from a luminance indicated by the image signal.

### BACKGROUND OF THE INVENTION

### Field of the Invention

The present disclosure relates to a display device which is illuminated by a backlight and displays an image.

### Description of the Background Art

A technique called local dimming, which is applied to a liquid crystal display device and divides a backlight into a plurality of areas and controls the luminance for each of the plurality of divided areas, is known. By virtue of the local dimming, since the backlight can be finely adjusted in accordance with the brightness of a projected image, the local dimming contributes to improving the visibility of a display and reducing power consumption. However, the local dimming has a problem in that, in a scene with motion, turning on and off of the backlight causes flickering which is noticeable to a viewer.

Thus, for example, a conventional technology indicates a liquid crystal display device which includes a plurality of illumination areas, in which the area or the arrangement position of each of the illumination areas is changed for each arbitrary time of change.

However, in the conventional technology described above, the faster the movement of a target object being displayed on a screen is, the larger the area of the illumination area becomes. As a result, although the flickering is improved, due to the area of the illumination area being increased, it becomes difficult to obtain deep unraised black which is of a true black level, and the display quality is lowered.

An object of an aspect of the present disclosure is to realize a display device which not only improves flickering but also suppresses reduction in the display quality caused by raised blacks.

### SUMMARY OF THE INVENTION

In order to solve the above problem, a display device according to an aspect of the present disclosure includes: a display panel which displays a moving image on the basis of an image signal; a backlight which illuminates the display panel; and a backlight controller which divides the backlight into a plurality of areas, and controls a light-emission luminance of the backlight for each of the plurality of areas on the basis of the image signal, in which the backlight controller causes the light-emission luminance of the backlight in a first adjacent illumination area which is adjacent, in a direction in which an image included in the image signal moves, to the image to be changed from a luminance indicated by the image signal.

In order to solve the above problem, a display method according to an aspect of the present disclosure pertains to a display method in a display device including a display panel which displays a moving image on the basis of an image signal, and a backlight which illuminates the display panel, wherein the display method includes: a step of receiving input of an image signal; and a backlight control step of dividing the backlight into a plurality of areas, and controlling a light-emission luminance of the backlight for each of the plurality of areas on the basis of the image signal, in which in the backlight control step, the light-emission luminance of the backlight in a first adjacent illumination area, which is adjacent, in a direction in which an image included in the image signal moves, to the image, is changed from a luminance indicated by the image signal.

According to an aspect of the present disclosure, not only is the flickering improved, but reduction in the display quality caused by raised blacks can also be suppressed.

### BRIEF DESCRIPTION OF THE DRAWINGS

FIG. 1 is a functional block diagram illustrating an outline of a display device according to Embodiment 1 of the present disclosure.

FIG. 2 is a diagram showing an example in which a backlight provided in the display device is divided into a plurality of areas.

FIG. 3 is a diagram for describing an area whose luminance is changed from the luminance indicated by an image signal.

FIG. 4 is a diagram for describing an area whose luminance is changed from the luminance indicated by an image signal.

FIG. 5 is a diagram for describing an area whose luminance is changed from the luminance indicated by an image signal.

FIG. 6 is a diagram for describing an area whose luminance is changed from the luminance indicated by an image signal.

FIG. 7 is a diagram for describing an area whose luminance is changed from the luminance indicated by an image signal.

FIG. 8 is a diagram for describing an area whose luminance is changed from the luminance indicated by an image signal.

FIG. 9 is a flowchart showing the flow of processing in a display device.

FIG. 10 is a functional block diagram illustrating an outline of a display device according to Embodiment 2 of the present disclosure.

FIG. 11 is a functional block diagram illustrating an outline of a display device according to Embodiment 3 of the present disclosure.

FIG. 12 is a diagram for describing a method of detecting, from a backlight difference, the direction in which a target image moves.

FIG. 13 is a flowchart showing the flow of processing in a display device.

### DESCRIPTION OF THE PREFERRED EMBODIMENTS

### Embodiment 1

An embodiment of the present disclosure will be described below in detail. In the present embodiment, a liquid crystal display device which is illuminated by a backlight and displays an image will be described as an example of a display device 1. The display device 1 according to the present embodiment can execute a technique called local dimming whereby a backlight 30 is divided into a plurality of areas to enable the luminance to be controlled for each of the plurality of areas. Further, the display device 1 can execute the so-called blur technique of lighting a peripheral area of a lit area of the backlight 30.

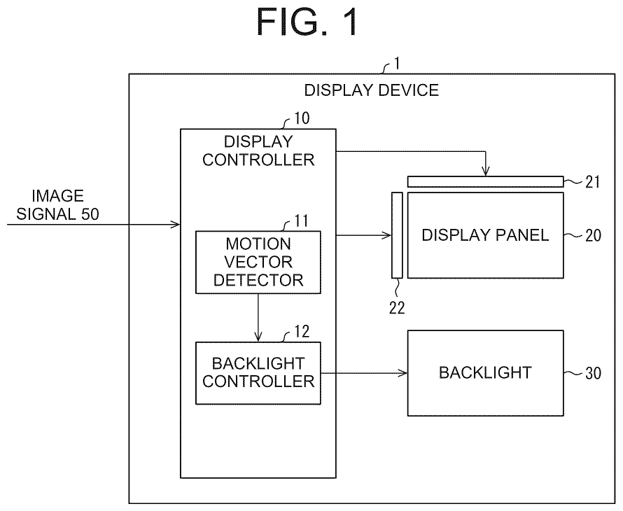

FIG. 1 is a functional block diagram illustrating an outline of the display device 1. As illustrated in FIG. 1, the display device 1 includes a display controller 10, a display panel 20, and the backlight 30.

The display controller 10 causes the display panel 20 to display an image based on an image signal 50 that has been input. Since the processing itself of displaying an image can be performed by using a known technique, a detailed description of the processing is omitted here. By the processing, a source driver circuit 21 and a gate driver circuit 22 receive a signal from the display controller 10, and an image is displayed on the display panel 20.

The display controller 10 includes a motion vector detector 11 (a first motion vector detector) and a backlight controller 12. The motion vector detector 11 detects a motion vector of an image from the image signal 50. The motion vector is a vector indicating a displacement between the position of a target in a certain frame of a moving image and the position of a corresponding target in a different frame.

The backlight controller 12 controls the backlight 30 by using the image signal 50 and the motion vector that has been detected by the motion vector detector 11. Further, the backlight controller 12 performs the above-described local dimming.

Note that in controlling the backlight 30, the backlight controller 12 may receive data indicating the actual illuminated state from the backlight 30 and control the backlight 30 on the basis of the data. That is, the backlight controller 12 may control the backlight 30 by receiving feedback from the backlight 30.

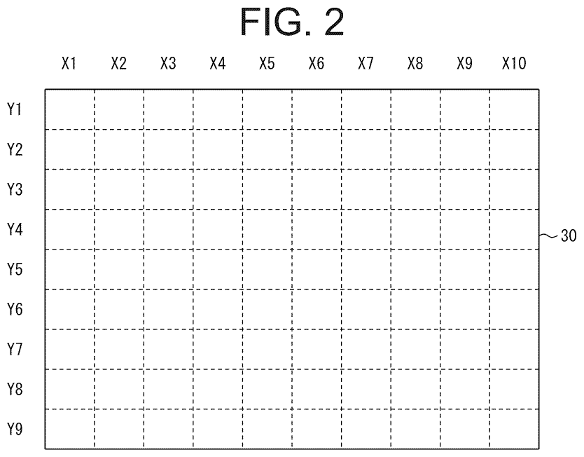

FIG. 2 shows an example in which the backlight 30 is divided into a plurality of areas in order to execute the local dimming. In the example shown in FIG. 2, the backlight 30 is divided into 90 areas in arrangement of 9-vertical-by-10-horizontal areas. In the present specification, in representing the position of each area, the position is represented by coordinates as described below. That is, by assuming the up-down direction of the backlight 30 as a Y direction and the right-left direction of the same as an X direction, and specifying each point from top to bottom in a vertical direction as Y1 to Y9 and each point from left to right in a horizontal direction as X1 to X10, the position of each of the areas is indicated by the X, Y coordinates. For example, the upper left area of the backlight 30 is defined as (X1, Y1), and the areas are sequentially defined as (X2, Y1), (X3, Y1), (X4, Y1), . . . , from this area to the right. Also, the areas are sequentially defined as (X1, Y1), (X1, Y2), (X1, Y3), . . . , from the upper left area to the bottom. The luminance can be controlled for each of the plurality of areas by the local dimming. Details of the processing performed by the backlight controller 12 will be described later.

### Details of Processing Performed by Backlight Controller 12

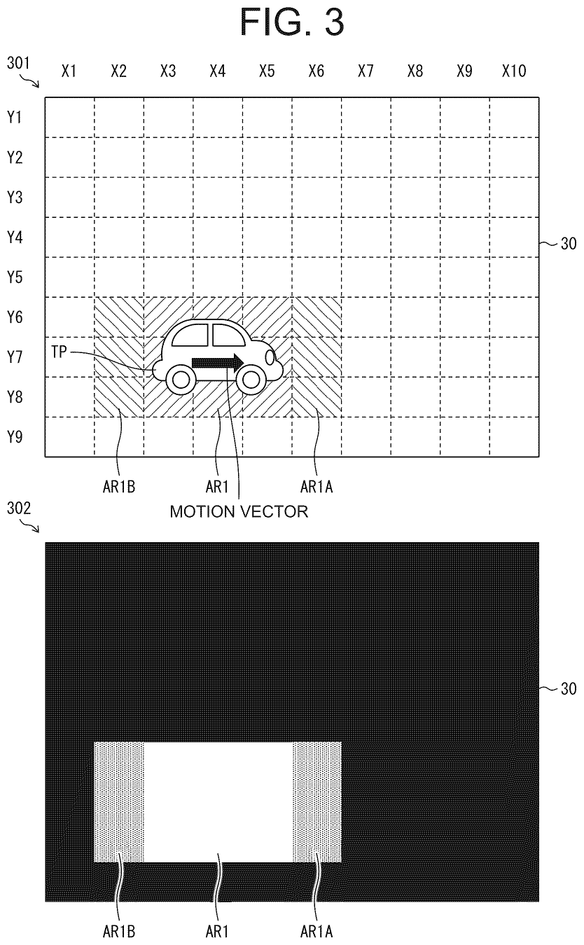

Next, details of the processing performed by the backlight controller 12 will be described with reference to FIGS. 3 to 8. As described above, the backlight controller 12 controls the backlight 30 by using the image signal 50 and the motion vector that has been detected by the motion vector detector 11.

More specifically, for a moving image, when an area of the backlight 30 corresponding to the moving image is assumed as a corresponding illumination area, the backlight controller 12 causes the light-emission luminance of an adjacent illumination area (a first adjacent illumination area), which is the area adjacent to the corresponding illumination area in a motion vector direction of the image, to be changed from the light-emission luminance indicated by the image signal 50. For example, the light-emission luminance of the adjacent illumination area is changed to a luminance that is higher than the light-emission luminance indicated by the image signal 50. If the luminance of the adjacent illumination area is set to the luminance indicated by the image signal 50, the luminance of the adjacent illumination area becomes too much different from that of the corresponding illumination area, and there is a possibility that flickering may occur in accordance with the movement of the image. As described above, by making the luminance of the adjacent illumination area higher than the light-emission luminance indicated by the image signal 50, a difference in luminance between the adjacent illumination area and the corresponding illumination area is reduced, and thus, the flickering can be suppressed.

The backlight controller 12 may perform the lighting such that the light-emission luminance of the adjacent illumination area is higher than the light-emission luminance indicated by the image signal 50, and lower than the light-emission luminance of the corresponding illumination area. Consequently, it is possible to suppress raised blacks while preventing flickering due to the movement of an image TP from which a motion vector is detected, and thus, the flickering and the raised blacks can be suppressed in good balance.

The following is the explanation based on a specific example. Reference numeral 301 in FIG. 3 denotes the backlight 30 and the image TP that is displayed on the display panel 20. An area AR1 of the backlight 30 corresponding to the image TP serves as the corresponding illumination area. With reference to the position coordinates described above, the area AR1 in which the upper left position is represented as (X3, Y6) and the lower right position is represented as (X5, Y8) is the corresponding illumination area. Further, an area AR1A ((X6, Y6), (X6, Y7), (X6, Y8)) and an area AR1B ((X2, Y6), (X2, Y7), (X2, Y8)), which are the areas adjacent to the area AR1 in a motion vector direction of the image TP (i.e., the X direction in this example), are the adjacent illumination areas.

Reference numeral 302 in FIG. 3 indicates an image of illumination by the backlight 30 when the image TP indicated by reference numeral 301 is displayed. As indicated by reference numeral 302 in FIG. 3, when the image TP is displayed, the area AR1 corresponding to the illumination area is illuminated, and also, the area AR1A and the area AR1B, which are the adjacent illumination areas adjacent to the illumination area in the motion vector direction, are illuminated. Here, the figure indicates the state in which the luminance of the area AR1A and the area AR1B is lower than the luminance of the area AR1.

The backlight controller 12 may cause the light-emission luminance of the adjacent illumination area to be varied according to the magnitude of the motion vector. For example, the backlight controller 12 may increase the light-emission luminance as the magnitude of the motion vector is increased.

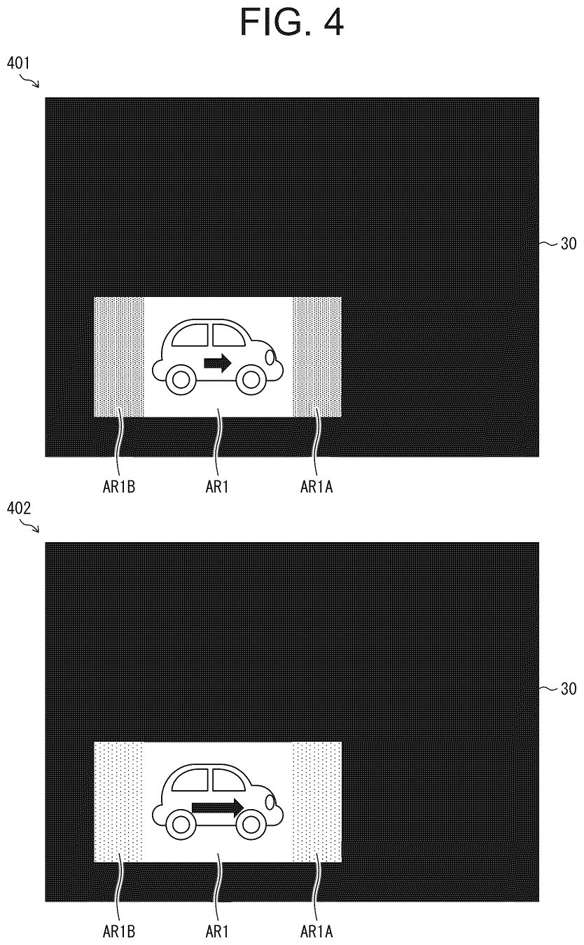

FIG. 4 shows an example of a difference between the magnitudes of the motion vectors and the light-emission luminances in the adjacent illumination areas. FIG. 4 shows an example in which the motion vector of the image TP indicated by reference numeral 402 is larger than the motion vector of the image TP indicated by reference numeral 401. As indicated in FIG. 4, the light-emission luminance of the adjacent illumination area (the area AR1A and the area AR1B) in 401 is less than that of the adjacent illumination area (the area AR1A and the area AR1B) in 402. The magnitude of the motion vector indicates the speed of the movement of the image TP. Thus, by changing the light-emission luminance of the adjacent illumination area according to the magnitude of the motion vector, the light-emission luminance can be set to correspond to the speed of the movement of the image TP. As a result, it is possible to suppress, in good balance, flickering due to the movement of the image TP and raised blacks.

When the magnitude of the motion vector exceeds a threshold value, the backlight controller 12 may also change the light-emission luminance of the adjacent illumination area that is adjacent to the corresponding illumination area in a direction different from the direction of the motion vector, in addition to the adjacent illumination area that is adjacent in the direction of the motion vector.

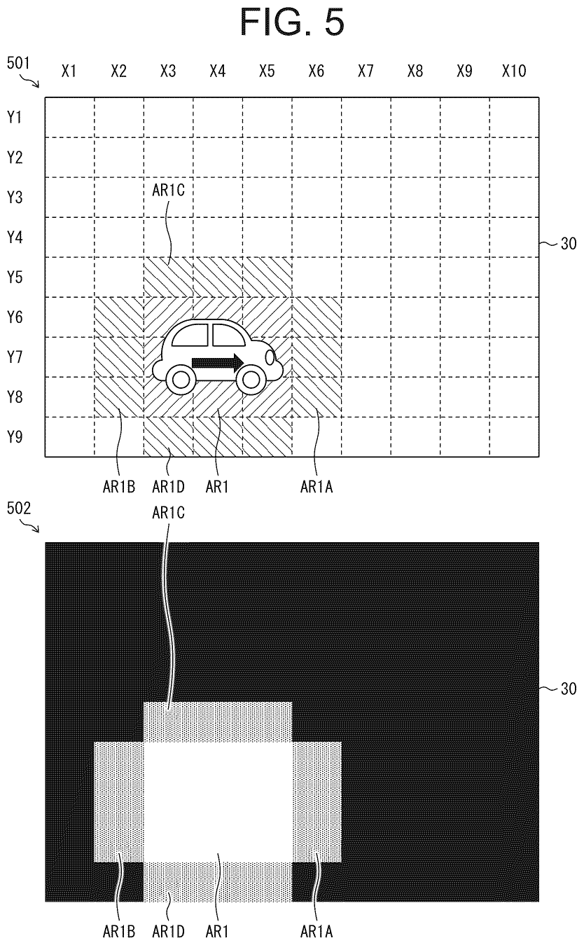

FIG. 5 illustrates an area of the backlight 30 in which the light-emission luminance is to be changed when the magnitude of the motion vector exceeds the threshold value. Reference numeral 501 in FIG. 5 denotes the backlight 30 and an image that is displayed on the display panel 20, and reference numeral 502 indicates an image of illumination by the backlight 30 when the image indicated by reference numeral 501 is displayed. As indicated by reference numeral 501 in FIG. 5, when the magnitude of the motion vector exceeds the threshold value, the backlight controller 12 may change the light-emission luminance of an area AR1C ((X3, Y5), (X4, Y5), (X5, Y5)) and an area AR1D ((X3, Y9), (X4, Y9), (X5, Y9)), in addition to the area AR1A ((X6, Y6), (X6, Y7), (X6, Y8)) and the area AR1B ((X2, Y6), (X2, Y7), (X2, Y8)) that are adjacent to the area AR1.

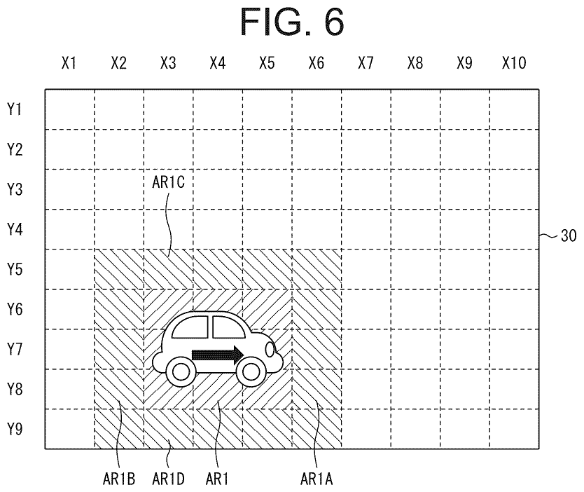

In addition, as illustrated in FIG. 6, the backlight controller 12 may also change the light-emission luminance of areas (X2, Y5), (X6, Y5), (X2, Y9), and (X6, Y9) where corner parts at the four corners of the area AR1 are in contact with each other, in addition to the area AR1A, the area AR1B, the area AR1C, and the area AR1D.

Among the adjacent illumination areas that are adjacent to the illumination area, the adjacent illumination area that is adjacent in the motion vector direction is referred to as a first adjacent illumination area, and the adjacent illumination area that is adjacent in a direction different from the motion vector direction is referred to as a second adjacent illumination area. In this case, the area AR1A and the area AR1B correspond to the first adjacent illumination area, and the area AR1C and the area AR1D correspond to the second adjacent illumination area.

When the magnitude of the motion vector exceeds the threshold value, the light-emission luminance of the second adjacent illumination area is also changed in addition to the first adjacent illumination area. That is, when the speed of the movement of the image TP is higher than a threshold value, the illumination area in which the light-emission luminance is to be changed is increased. Thus, flickering due to the movement of the image can further be suppressed.

The backlight controller 12 may also change, according to the magnitude of the motion vector, the light-emission luminance of an area that is adjacent to the adjacent illumination area in a direction of the motion vector. Further, the backlight controller 12 may increase, as the magnitude of the motion vector is increased, the area in which the light-emission luminance is changed, in the motion vector direction. In other words, the backlight controller 12 may also change, according to the magnitude of the motion vector, the light-emission luminance of a third adjacent illumination area that is adjacent to the first adjacent illumination area in the direction of the motion vector.

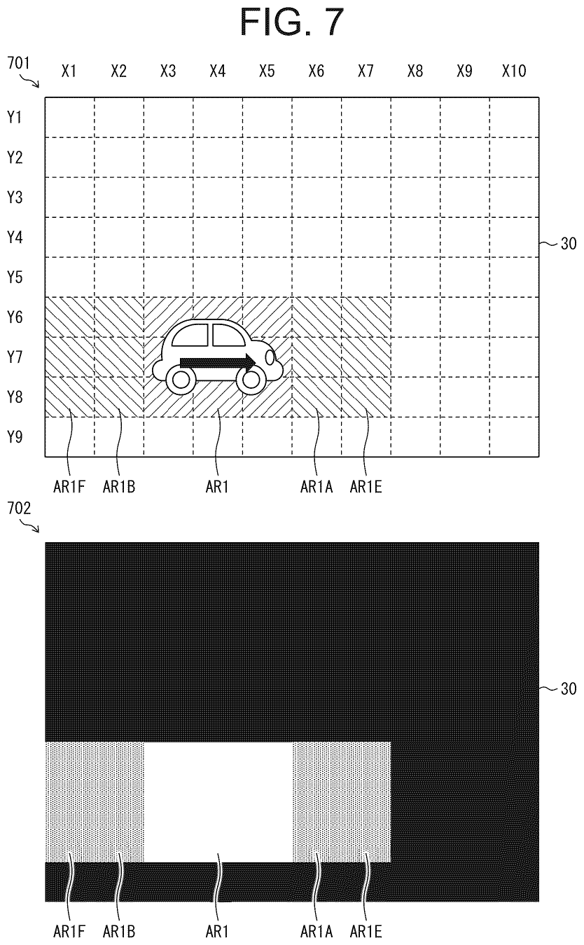

FIG. 7 shows an example of an area of the backlight 30 in which the light-emission luminance is changed according to the magnitude of the motion vector. Reference numeral 701 in FIG. 7 denotes the backlight 30 and an image that is displayed on the display panel 20, and reference numeral 702 indicates an image of illumination by the backlight 30 when the image indicated by reference numeral 701 is displayed. In the example described above, the light-emission luminance of the area AR1A and the area AR1B, which are adjacent to the area AR1 as the illumination area in the motion vector direction, has been changed. In the present example, as the motion vector is increased, the backlight controller 12 also changes the light-emission luminance of an area AR1E ((X7, Y6), (X7, Y7), (X7, Y8)) and an area AR1F ((X1, Y6), (X1, Y7), (X1, Y8)), which are adjacent to the area AR1A and the area AR1B in the motion vector direction, respectively. In this example, the area AR1A and the area AR1B correspond to the first adjacent illumination area, and the area AR1E and the area AR1F correspond to the third adjacent illumination area.

Further, when the magnitude of the motion vector is increased, the backlight controller 12 may change the light-emission luminance of an area ((X8, Y6), (X8, Y7), (X8, Y8)) that is adjacent to the area AR1E in the motion vector direction. That is, the third adjacent illumination area in which the light-emission luminance is to be changed may be increased in the motion vector direction.

Consequently, the illumination area in which the light-emission luminance is to be changed can be increased in a direction of movement of the image TP in accordance with the speed of the movement of the image TP. Thus, it is possible to further suppress flickering due to the movement of the image TP.

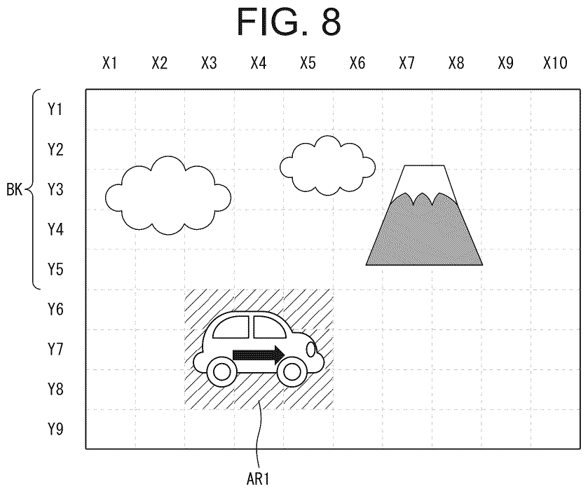

The backlight controller 12 may determine the light-emission luminance of the adjacent illumination area in accordance with a luminance difference between the image TP from which the motion vector based on the image signal 50 is detected and a background. For example, in the case of displaying an image as illustrated in FIG. 8, the luminance of the adjacent illumination area may be increased as a difference between the luminance of the image TP and the luminance of the background, such as the luminance of an area BK, is increased. Consequently, since the light-emission luminance of the adjacent illumination area is determined in accordance with the luminance difference between the image TP from which the motion vector is detected and the background, the light-emission luminance of the adjacent illumination area can be set also in consideration of the background. By virtue of this feature, the image TP and the background can be illuminated in good balance, and a sense of discomfort felt by a viewer for the image as a whole can be reduced.

The backlight controller 12 may determine the light-emission luminance of the adjacent illumination area according to a signal level of the screen as a whole based on the image signal 50. For example, the backlight controller 12 may increase the light-emission luminance of the adjacent illumination area as the signal level of the screen as a whole based on the image signal 50 is increased. Here, the signal level is intended as a gradation indicated by the image signal 50, and the signal level of the screen as a whole is intended as the mean value of the gradations of the screen as a whole, that is, all of the pixels included in one frame. By determining the luminance of the adjacent illumination area according to the signal level of the screen as a whole, the light-emission luminance in consideration of the smoothness of the screen as a whole can be set. By virtue of this feature, a sense of discomfort felt by a viewer for the image can be reduced.

The backlight controller 12 may determine the light-emission luminance of the adjacent illumination area according to a luminance level of the screen as a whole based on the image signal 50. For example, the backlight controller 12 may increase the light-emission luminance of the adjacent illumination area as the luminance level of the screen as a whole based on the image signal 50 is increased. Here, the luminance level is intended as the mean value of the luminances of the screen as a whole. By using the mean value of the luminances of the screen as a whole as the luminance level, it is possible to make the light-emission luminance of the adjacent illumination area close to the actual state. For example, in the case of an image in which a white window is displayed against a black background, if the size of the window is small, a median value is black. Therefore, the light-emission luminance is determined to correspond to a dark image. Meanwhile, the mean value represents some brightness, and the light-emission luminance is determined to correspond to an image having brightness. Therefore, by using the mean value, the light-emission luminance can be made the luminance that is close to the actual state. Note that a median value of the luminances of the screen as a whole may be used as the luminance level.

By determining the light-emission luminance of the adjacent illumination area according to the luminance level of the screen as a whole, the light-emission luminance in consideration of the brightness of the screen as a whole can be set. By virtue of this feature, a sense of discomfort felt by a viewer for the image can be reduced.

### Flow of Processing in Display Device 1

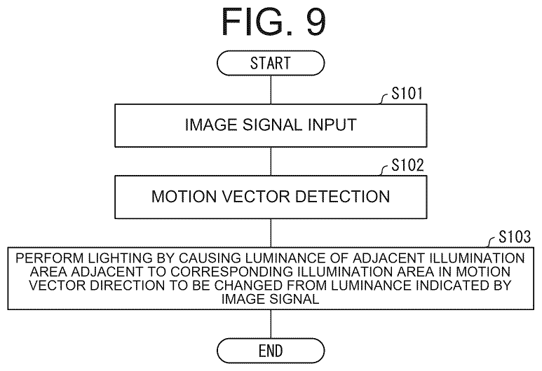

Next, a flow of processing in the display device 1 will be described with reference to FIG. 9. FIG. 9 is a flowchart showing the flow of processing in the display device 1. As indicated in FIG. 9, when the image signal 50 is input to the display device 1 (S101), the motion vector detector 11 detects a motion vector of an image included in the image signal 50 (S102, a motion vector detection step). Then, in displaying the image represented by the image signal 50 on the display panel 20, the display controller 10 performs the display with the illumination by the backlight 30 conducted as described below. That is, the backlight controller 12 turns on the backlight 30 by causing the light-emission luminance of the adjacent illumination area which is adjacent, in the motion vector direction, to the illumination area corresponding to the image for which the motion vector detector 11 has detected the motion vector to be changed from the light-emission luminance indicated by the image signal 50 (S103, a backlight control step). Consequently, the image is displayed in a state in which the adjacent illumination area is illuminated. The above is the flow of processing in the display device 1.

### Embodiment 2

Other embodiments of the present disclosure will be described below. For convenience of explanation, members having the same functions as those described in the above embodiment are denoted by the same reference numerals, and description thereof is not repeated.

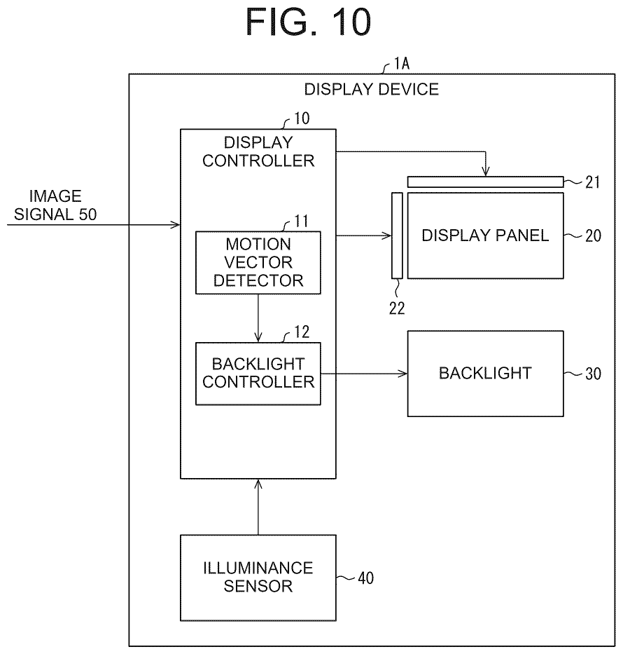

FIG. 10 is a functional block diagram illustrating a configuration of the essential parts of a display device 1A according to the present embodiment. As illustrated in FIG. 10, the display device 1A according to the present embodiment is different from the above-described display device 1 in that an illuminance sensor 40 is provided.

The illuminance sensor 40 measures the illuminance in an environment in which the display device 1A is disposed, and notifies a display controller 10 of the measurement result. A backlight controller 12 of the display controller 10 determines the light-emission luminance of an adjacent illumination area by using the measurement result given by the illuminance sensor 40. For example, the backlight controller 12 may increase the light-emission luminance of the adjacent illumination area as the illuminance in the measurement result given by the illuminance sensor 40 is increased.

Consequently, since the light-emission luminance of the adjacent illumination area can be determined according to the brightness of the surrounding environment of the display device 1A, the light-emission luminance in consideration of the brightness of the surrounding environment of the display device 1A can be set.

### Modifications

Although the configuration in which the illuminance sensor 40 is used has been described above, the present disclosure is not limited thereto, and the display device 1 may have a configuration including a temperature sensor, a watt-hour meter, and the like.

For example, in the case of a configuration including a temperature sensor, the backlight controller 12 may determine the light-emission luminance of the adjacent illumination area according to the temperature of the display device 1 measured by the temperature sensor. Consequently, it is possible to prevent the temperature of the display device 1 from becoming too high.

Further, in the case of a configuration including a watt-hour meter, the backlight controller 12 may determine the light-emission luminance of the adjacent illumination area according to the power consumption of the display device 1 measured by the watt-hour meter. Consequently, it is possible to prevent the power consumption of the display device 1 from becoming too large.

### Embodiment 3

Other embodiments of the present disclosure will be described below. For convenience of explanation, members having the same functions as those described in the above embodiment are denoted by the same reference numerals, and description thereof is not repeated.

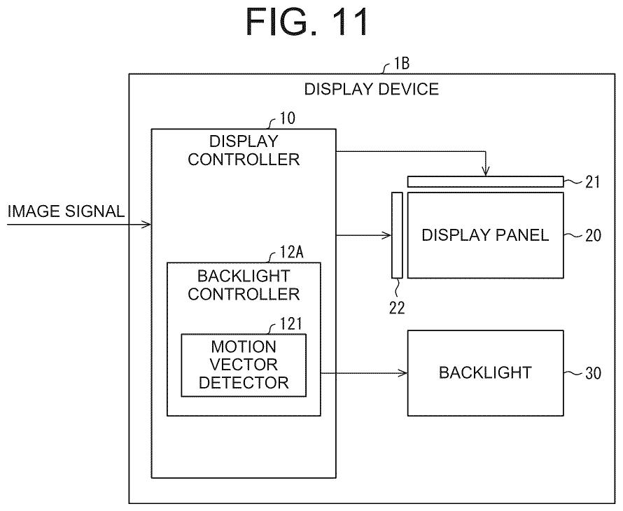

FIG. 11 is a functional block diagram illustrating a configuration of the essential parts of a display device 1B according to the present embodiment. As illustrated in FIG. 11, the display device 1B according to the present embodiment is different from the above-described display devices 1, 1A in that a backlight controller 12A includes a motion vector detector 121 (a second motion vector detector).

The motion vector detector 121 detects, on the basis of the light-emission luminance of a backlight 30 realized by the backlight controller 12A, a motion vector indicating the movement of a target image, which is a moving image. More specifically, the following is performed.

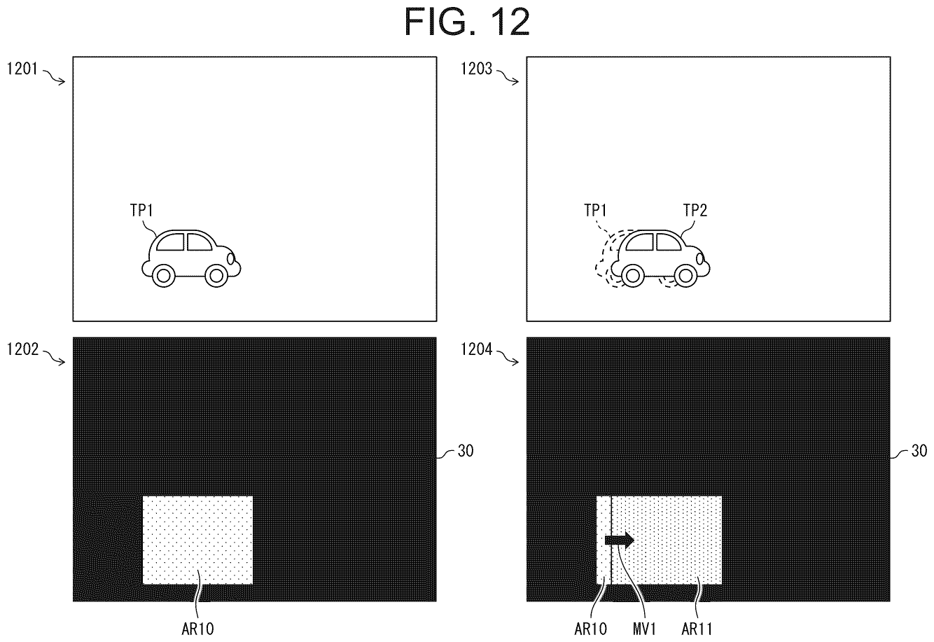

FIG. 12 is a diagram for describing a method of detecting, from a difference between the light-emission luminances of the backlight 30, a direction in which a target image TP1, which is the image included in an image signal 50, moves as the motion vector. Reference numeral 1201 in FIG. 12 indicates an example in which the target image TP1 is displayed in a certain frame. Further, reference numeral 1202 indicates an example of the light-emitting state of the backlight 30 in this frame. As indicated by reference numeral 1202, when the target image TP1 is displayed as indicated by reference numeral 1201, the backlight controller 12A turns on the backlight 30 such that the luminance in an area AR10 as the area corresponding to the target image TP1 becomes high.

Reference numeral 1203 in FIG. 12 denotes a frame subsequent to the frame of 1201. Here, a target image TP2 is displayed. The target image TP2 is the same image as the target image TP1, and the position of display is moved from that in the frame indicated by 1201. Further, reference numeral 1204 indicates an example of the light-emitting state of the backlight 30 in this frame. As indicated by reference numeral 1204, when the target image TP2 is displayed as indicated by reference numeral 1203, the backlight controller 12A turns on the backlight 30 such that the luminance in an area AR11 as the area corresponding to the target image TP2 becomes high.

As can be seen, the light-emitting state of the backlight 30 varies between frames. The motion vector detector 121 detects the direction in which the target image moves from the difference in the light-emission luminance of the backlight 30 between the frames. Here, a motion vector MV1 is detected from a change in the position between the area AR10 and the area AR11, which are the areas where the light-emission luminance is high.

As described above, the motion vector detector 121 of the backlight controller 12A detects the direction in which the target image moves by using a difference between the light-emission luminance corresponding to a certain frame and the light-emission luminance corresponding to a frame that comes next to the certain frame in a moving image. The above can be rephrased as detecting a difference between the light-emission luminances of the backlight 30 as the motion vector. Consequently, since the direction in which the target image moves can be detected from the difference between the light-emission luminances of the backlight, the direction in which the target image moves can be detected only from data on the backlight. Therefore, the detection of the direction in which the target image moves can be processed as part of the backlight control. In other words, the detection of the motion vector can be processed as part of the backlight control.

Note that, in the detection of the difference in the backlight 30 between the frames, a frame to be compared with a certain frame need not necessarily be the next frame that is temporally continuous. For example, a difference between a certain frame and a frame that comes after a predetermined time has elapsed may be used, or a difference between a certain frame and a frame that comes after a predetermined number of frames have skipped may be used.

### Flow of Processing in Display Device 1B

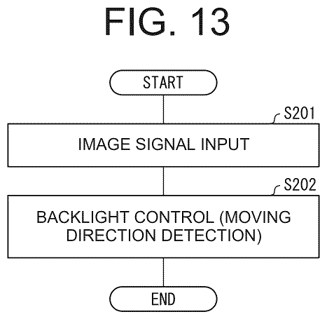

Next, a flow of processing in the display device 1B will be described with reference to FIG. 13. FIG. 13 is a flowchart showing the flow of processing in the display device 1B. As indicated in FIG. 13, when the image signal 50 is input to the display device 1B (S201), in displaying an image represented by the image signal 50 on a display panel 20, a display controller 10 performs the display with the illumination by the backlight 30 conducted as described below. That is, the backlight controller 12A turns on the backlight 30 by causing the light-emission luminance of an adjacent illumination area which is adjacent, in a motion vector direction, to an illumination area corresponding to the image for which the motion vector detector 121 has detected the motion vector to be changed from the light-emission luminance indicated by the image signal 50 (S202, a backlight control step). Consequently, the image is displayed in a state in which the adjacent illumination area is illuminated. The above is the flow of processing in the display device 1B.

As described above, the display device 1, 1A, 1B according to the present disclosure is provided with: the display panel 20 which displays a moving image on the basis of the image signal 50; the backlight 30 which illuminates the display panel 20; and the backlight controller 12, 12A. The backlight controller 12, 12A divides the backlight 30 into a plurality of areas, and controls the light-emission luminance of the backlight 30 for each of the plurality of areas on the basis of the image signal 50. Further, the backlight controller 12, 12A causes the light-emission luminance of the backlight 30 in the first adjacent illumination area, which is adjacent to the corresponding illumination area corresponding to the target image in the moving image in a direction in which the target image moves, to be changed from the luminance indicated by the image signal 50. In other words, the backlight controller 12, 12A causes the light-emission luminance of the backlight 30 in the first adjacent illumination area which is adjacent, in the direction in which the image (target image) included in the image signal 50 moves, to the image to be changed from the luminance indicated by the image signal 50.

Consequently, the light-emission luminance of the first adjacent illumination area that is adjacent to the corresponding illumination area in the direction in which the target image moves is changed. Therefore, since the whole corresponding illumination area is not enlarged as in the conventional technology, it is possible to narrow the area in which raised blacks may occur in the image. By virtue of this feature, not only is the flickering improved, but reduction in the display quality caused by raised blacks can also be suppressed.

Note that the target image is not limited to images included in the image signal, but may be a character, an avatar, or the like, generated by the display device 1 itself. Also, the target image may be a character, an avatar, or the like, generated by a server, etc., which is different from a source of transmission of the image signal. The character, the avatar, or the like, may be generated by the same server, etc., which is the source of transmission of the image signal. The avatar is a character registered in a virtual space. The images of these characters, avatars, and the like, are displayed in combination with the moving image (content image) represented by the image signal 50. The content image and the image of the character, the avatar, and the like, may be displayed to overlap one another, or may be displayed in different areas.

### Implementation Example by Software

The function of the display device 1 (hereinafter referred to as a “device”) can be implemented by a program for causing a computer to function as the device, more specifically, a program for causing the computer to function as each control block (particularly, each unit included in the display controller 10) of the device.

In this case, the above device is provided with a computer including at least one control device (for example, a processor) and at least one storage device (for example, a memory) as hardware for executing the program. As the above-mentioned program is executed by the control device and the storage device, the respective functions described in the above embodiments are implemented.

The above-mentioned program may be recorded in one or more non-transitory computer-readable recording media. The recording medium may or may not be provided in the above device. In the latter case, the above-mentioned program may be supplied to the above device via an arbitrary wired or wireless transmission medium.

Further, a part of or all of the functions of the control blocks described above may be implemented by a logic circuit. For example, the scope of the present disclosure also includes an integrated circuit in which a logic circuit, which serves as each of the control blocks described above, is formed. In addition, the functions of the control blocks described above may be realized by a quantum computer.

Also, each process described in the above embodiments may be executed by artificial intelligence (AI). In this case, the AI may be operated in the above-mentioned control device or may be operated in another device (for example, an edge computer or a cloud server).

The present disclosure is not limited to each of the above-described embodiments, and various modifications can be made within the scope of the claims. Embodiments that are obtained by appropriately combining the technical measures respectively disclosed in the different embodiments also fall within the technical scope of the present disclosure. Furthermore, a new technical feature can be formed by combining the technical measures respectively disclosed in the embodiments.

### SUMMARY

A display device according to aspect 1 of the present disclosure includes: a display panel which displays a moving image on the basis of an image signal; a backlight which illuminates the display panel; and a backlight controller which divides the backlight into a plurality of areas, and controls a light-emission luminance of the backlight for each of the plurality of areas on the basis of the image signal, in which the backlight controller causes the light-emission luminance of the backlight in a first adjacent illumination area which is adjacent, in a direction in which an image included in the image signal moves, to the image to be changed from a luminance indicated by the image signal. According to the above configuration, the light-emission luminance of the first adjacent illumination area that is adjacent to the image in the direction in which the image moves is changed. Therefore, since the whole illumination area corresponding to the image is not enlarged as in the conventional technology, it is possible to narrow the area in which raised blacks may occur in the image. By virtue of this feature, not only is the flickering improved, but reduction in the display quality caused by raised blacks can also be suppressed.

A display device according to aspect 2 of the present disclosure includes, in the above aspect 1, a first motion vector detector which detects a motion vector of the image included in the image signal, and the backlight controller assumes the area which is adjacent, in a direction indicated by the motion vector which has been detected, to a corresponding illumination area corresponding to the image, as the first adjacent illumination area. According to the above configuration, the area adjacent to the corresponding illumination area in the direction indicated by the detected motion vector can be assumed as the first adjacent illumination area.

By a display device according to aspect 3 of the present disclosure, in the above aspect 1, the backlight controller detects the direction in which the target image moves by using a difference between the light-emission luminance corresponding to a certain frame and the light-emission luminance corresponding to a frame that comes next to the certain frame in the moving image. According to the above configuration, since the direction in which the target image moves can be detected from a difference between the light-emission luminances of the backlight, the direction in which the target image moves can be detected only from data on the backlight. Consequently, the detection of the direction in which the target image moves can be processed as part of the backlight control.

A display device according to aspect 4 of the present disclosure includes, in the above aspect 3, a second motion vector detector which detects a direction in which the target image moves as a motion vector. According to the above configuration, the direction in which the target image moves can be detected by using the motion vector.

By a display device according to aspect 5 of the present disclosure, in the above aspect 2 or 4, the backlight controller performs lighting such that the light-emission luminance of the first adjacent illumination area is lower than the light-emission luminance of the corresponding illumination area. According to the above configuration, since the light-emission luminance of the first adjacent illumination area is made lower than that of the corresponding illumination area, it is possible to suppress, in good balance, flickering due to the movement of an image from which a motion vector is detected and raised blacks.

By a display device according to aspect 6 of the present disclosure, in the above aspect 5, the backlight controller causes the light-emission luminance of the first adjacent illumination area to be varied according to the magnitude of the motion vector. According to the above configuration, the light-emission luminance can be set to correspond to the speed of the movement of the image from which the motion vector is detected, and it is possible to suppress, in good balance, flickering due to the movement of the image and raised blacks.

By a display device according to aspect 7 of the present disclosure, in the above aspect 5 or 6, the backlight controller also changes, when the magnitude of the motion vector exceeds a threshold value, the light-emission luminance of a second adjacent illumination area that is adjacent to the corresponding illumination area in a direction different from a direction of the motion vector, in addition to the first adjacent illumination area. According to the above configuration, when the speed of the movement of an image from which the motion vector is detected is higher than the threshold value, the illumination area in which the light-emission luminance is to be changed is increased, and thus, flickering due to the movement of the image can further be suppressed.

By a display device according to aspect 8 of the present disclosure, in any one of the above aspects 5 to 7, the backlight controller also changes, according to the magnitude of the motion vector, the light-emission luminance of a third adjacent illumination area that is adjacent to the first adjacent illumination area in a direction of the motion vector. According to the above configuration, the illumination area in which the light-emission luminance is to be changed can be increased in a direction of movement of the image in accordance with the speed of the movement of the image from which the motion vector is detected. Thus, it is possible to further suppress flickering due to the movement of the image.

By a display device according to aspect 9 of the present disclosure, in any one of the above aspects 5 to 8, the backlight controller increases, as the magnitude of the motion vector is increased, the third adjacent illumination area in which the light-emission luminance is changed, in the motion vector direction. According to the above configuration, the illumination area in which the light-emission luminance is to be changed can be increased in the direction of the movement of the image, in accordance with the speed of the movement of the image from which the motion vector is detected. Thus, it is possible to further suppress flickering due to the movement of the image.

By a display device according to aspect 10 of the present disclosure, in any one of the above aspects 5 to 9, the backlight controller determines the light-emission luminance of the first adjacent illumination area in accordance with a luminance difference between the image from which the motion vector based on the image signal is detected and a background. According to the above configuration, since the light-emission luminance of the first adjacent illumination area is determined in accordance with the luminance difference between the image from which the motion vector is detected and the background, the light-emission luminance also in consideration of the background can be set. By virtue of this feature, a sense of discomfort felt by a viewer for the image can be reduced.

By a display device according to aspect 11 of the present disclosure, in any one of the above aspects 1 to 10, the backlight controller determines the light-emission luminance of the first adjacent illumination area according to a signal level of a screen as a whole based on the image signal. According to the above configuration, since the light-emission luminance of the first adjacent illumination area is determined according to the signal level of the screen as a whole, the light-emission luminance in consideration of the smoothness of the screen as a whole can be set. By virtue of this feature, a sense of discomfort felt by a viewer for the image can be reduced. Here, the signal level is intended as the mean value of the gradations of the screen as a whole.

By a display device according to aspect 12 of the present disclosure, in any one of the above aspects 1 to 11, the backlight controller determines the light-emission luminance of the first adjacent illumination area according to a luminance level of the screen as a whole based on the image signal. According to the above configuration, since the light-emission luminance of the first adjacent illumination area is determined according to the luminance level of the screen as a whole, the light-emission luminance in consideration of the brightness of the screen as a whole can be set. By virtue of this feature, a sense of discomfort felt by a viewer for the image can be reduced. Here, the luminance level is intended as the mean value or median value of the luminances of the screen as a whole.

A display device according to aspect 13 of the present disclosure includes, in any one the above aspects 1 to 12, an illuminance sensor, and the backlight controller determines the light-emission luminance of the first adjacent illumination area in accordance with a measurement result of the illuminance sensor. According to the above configuration, since the light-emission luminance of the first adjacent illumination area is determined according to the brightness of the surrounding environment of the display device, the light-emission luminance in consideration of the brightness of the surrounding environment of the display device can be set.

A display method according to aspect 14 of the present disclosure pertains to a display method in a display device including a display panel which displays a moving image on the basis of an image signal, and a backlight which illuminates the display panel, and the display method includes: a step of receiving input of an image signal; and a backlight control step of dividing the backlight into a plurality of areas, and controlling a light-emission luminance of the backlight for each of the plurality of areas on the basis of the image signal, in which in the backlight control step, the light-emission luminance of the backlight in a first adjacent illumination area, which is adjacent, in a direction in which an image included in the image signal moves, to the image, is changed from a luminance indicated by the image signal.

The display device according to each aspect of the present disclosure may be realized by a computer. In this case, a control program of a display device, which causes the computer to operate as each unit (software element) provided in the above-described display device, thereby realizing the above-described display device by the computer, and a computer-readable recording medium having the control program recorded therein also fall within the scope of the present disclosure.

What is claimed is:

1. A display device comprising:
a display panel which displays a moving image based on an image signal;
a backlight which illuminates the display panel; and
a backlight controller which divides the backlight into a plurality of areas, and controls a light-emission luminance of the backlight for each of the plurality of areas based on the image signal, wherein
the backlight controller causes the light-emission luminance of the backlight in a first adjacent illumination area which is adjacent, in a direction in which an image included in the image signal moves, to the image to be changed from a luminance indicated by the image signal.

2. The display device according to claim 1, further comprising a first motion vector detector which detects a motion vector of the image included in the image signal, wherein
the backlight controller assumes the area which is adjacent, in a direction indicated by the motion vector which has been detected, to a corresponding illumination area corresponding to the image, as the first adjacent illumination area.

3. The display device according to claim 1, wherein the backlight controller detects the direction in which the image moves by using a difference between the light-emission luminance corresponding to a certain frame and the light-emission luminance corresponding to a frame that comes next to the certain frame in the moving image.

4. The display device according to claim 3, further comprising a second motion vector detector which detects a difference between the light-emission luminances of the backlight as a motion vector.

5. The display device according to claim 2, wherein the backlight controller performs lighting such that the light-emission luminance of the first adjacent illumination area is lower than the light-emission luminance of the corresponding illumination area.

6. The display device according to claim 2, wherein the backlight controller causes the light-emission luminance of the first adjacent illumination area to be varied according to magnitude of the motion vector.

7. The display device according to claim 2, wherein the backlight controller also changes, when magnitude of the motion vector exceeds a threshold value, the light-emission luminance of a second adjacent illumination area that is adjacent to the corresponding illumination area in a direction different from a direction of the motion vector, in addition to the first adjacent illumination area.

8. The display device according to claim 2, wherein the backlight controller also changes, according to magnitude of the motion vector, the light-emission luminance of a third adjacent illumination area that is adjacent to the first adjacent illumination area in a direction of the motion vector.

9. The display device according to claim 8, wherein the backlight controller increases, as the magnitude of the motion vector is increased, the third adjacent illumination area in which the light-emission luminance is changed, in the motion vector direction.

10. The display device according to claim 2, wherein the backlight controller determines the light-emission luminance of the first adjacent illumination area in accordance with a luminance difference between the image from which the motion vector based on the image signal is detected and a background.

11. The display device according to claim 1, wherein the backlight controller determines the light-emission luminance of the first adjacent illumination area according to a signal level of a screen as a whole based on the image signal.

12. The display device according to claim 1, wherein the backlight controller determines the light-emission luminance of the first adjacent illumination area according to a luminance level of a screen as a whole based on the image signal.

13. The display device according to claim 1, further comprising an illuminance sensor, wherein
the backlight controller determines the light-emission luminance of the first adjacent illumination area in accordance with a measurement result of the illuminance sensor.

14. A display method in a display device comprising a display panel which displays a moving image based on an image signal, and a backlight which illuminates the display panel, the display method comprising:
receiving input of an image signal; and
backlight controlling of dividing the backlight into a plurality of areas, and controlling a light-emission luminance of the backlight for each of the plurality of areas based on the image signal, wherein
in the backlight controlling, the light-emission luminance of the backlight in a first adjacent illumination area, which is adjacent, in a direction in which an image included in the image signal moves, to the image, is changed from a luminance indicated by the image signal.
